(19) United States
(12) Patent Application Publication
(10) Pub. No.: US 2002/0126484 A1
(43) Pub. Date: Sep. 12, 2002

(54) Dimmable multi-bulb light fixture

(76) Inventor: Goslaw Misztal, Long Beach, CA (US)

Correspondence Address: Richard W. Goldstein, 2071 Clove Road, Staten Island, NY, 10304, US

(21) Appl. No.: 09/805,005

(22) Filed: Mar. 12, 2001

(51) Int. Cl. F21V 23/04

(52) U.S. Cl. 362/251; 362/394

(57) ABSTRACT

A dimmable multi-bulb light fixture including a light portion including a base portion having a plurality of light sockets extending upwardly therefrom. The light sockets are positioned at different elevations and have an open upper end for receiving a light bulb therein. A control panel is in communication with the light portion. The control panel includes a single power cord extending outwardly therefrom for coupling with a standard electrical outlet. The control panel includes a power switch for controlling the three light sockets individually and jointly. The control panel includes a dimmer switch for controlling the three light sockets individually and jointly.

### BACKGROUND OF THE INVENTION

The present invention relates to a dimmable multi-bulb light fixture and more particularly pertains to allowing a single bulb to be controlled separately from other bulbs.

The use of illumination devices is known in the prior art. More specifically, illumination devices heretofore devised and utilized for the purpose of providing a light source are known to consist basically of familiar, expected and obvious structural configurations, notwithstanding the myriad of designs encompassed by the crowded prior art which have been developed for the fulfillment of countless objectives and requirements.

By way of example, U.S. Pat. No. 4,508,520 to Sellers discloses a heart-shaped lamp for novelty purposes. U.S. Pat. No. 4,782,543 to Cole discloses a lighting unit comprised of a plurality of separate lamps in a star-shaped housing, for producing a twinkling effect. U.S. Pat. No. 5,749,646 to Britell discloses a lamp for producing special effects with a number of different colors.

While these devices fulfill their respective, particular objective and requirements, the aforementioned patents do not describe a dimmable multi-bulb light fixture for allowing a single bulb to be controlled separately from other bulbs.

In this respect, the dimmable multi-bulb light fixture according to the present invention substantially departs from the conventional concepts and designs of the prior art, and in doing so provides an apparatus primarily developed for the purpose of allowing a single bulb to be controlled separately from other bulbs.

Therefore, it can be appreciated that there exists a continuing need for a new and improved dimmable multi-bulb light fixture which can be used for allowing a single bulb to be controlled separately from other bulbs. In this regard, the present invention substantially fulfills this need.

### SUMMARY OF THE INVENTION

In the view of the foregoing disadvantages inherent in the known types of illumination devices now present in the prior art, the present invention provides an improved dimmable multi-bulb light fixture. As such, the general purpose of the present invention, which will be described subsequently in greater detail, is to provide a new and improved dimmable multi-bulb light fixture which has all the advantages of the prior art and none of the disadvantages.

To attain this, the present invention essentially comprises a light portion including a base portion having three light sockets extending upwardly therefrom. The light sockets are positioned at different elevations and have an open upper end for receiving a light bulb therein. A control panel is in communication with the light portion. The control panel includes a single power cord extending outwardly therefrom for coupling with a standard electrical outlet. The control panel includes a power switch for controlling the three light sockets individually and jointly. The control panel includes a dimmer switch for controlling the three light sockets individually and jointly.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved dimmable multi-bulb light fixture which has all the advantages of the prior art illumination devices and none of the disadvantages.

It is another object of the present invention to provide a new and improved dimmable multi-bulb light fixture which may be easily and efficiently manufactured and marketed.

It is a further object of the present invention to provide a new and improved dimmable multi-bulb light fixture which is of durable and reliable construction.

An even further object of the present invention is to provide a new and improved dimmable multi-bulb light fixture which is susceptible of a low cost of manufacture with regard to both materials and labor, and which accordingly is then susceptible of low prices of sale to the consuming public, thereby making such dimmable multi-bulb light fixture economically available to the buying public.

Even still another object of the present invention is to provide a new and improved dimmable multi-bulb light fixture for allowing a single bulb to be controlled separately from other bulbs.

Lastly, it is an object of the present invention to provide a new and improved dimmable multi-bulb light fixture including a light portion including a base portion having three light sockets extending upwardly therefrom. The light sockets are positioned at different elevations and have an open upper end for receiving a light bulb therein. A control panel is in communication with the light portion. The control panel includes a single power cord extending outwardly therefrom for coupling with a standard electrical outlet. The control panel includes a power switch for controlling the three light sockets individually and jointly. The control panel includes a dimmer switch for controlling the three light sockets individually and jointly.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of the preferred embodiment of the dimmable multi-bulb light fixture constructed in accordance with the principles of the present invention.

FIG. 2 is a cross-sectional front view of the housing of the present invention.

FIG. 3 is a schematic illustration of the operability of the present invention.

The same reference numerals refer to the same parts through the various figures.

### DESCRIPTION OF THE PREFERRED EMBODIMENT

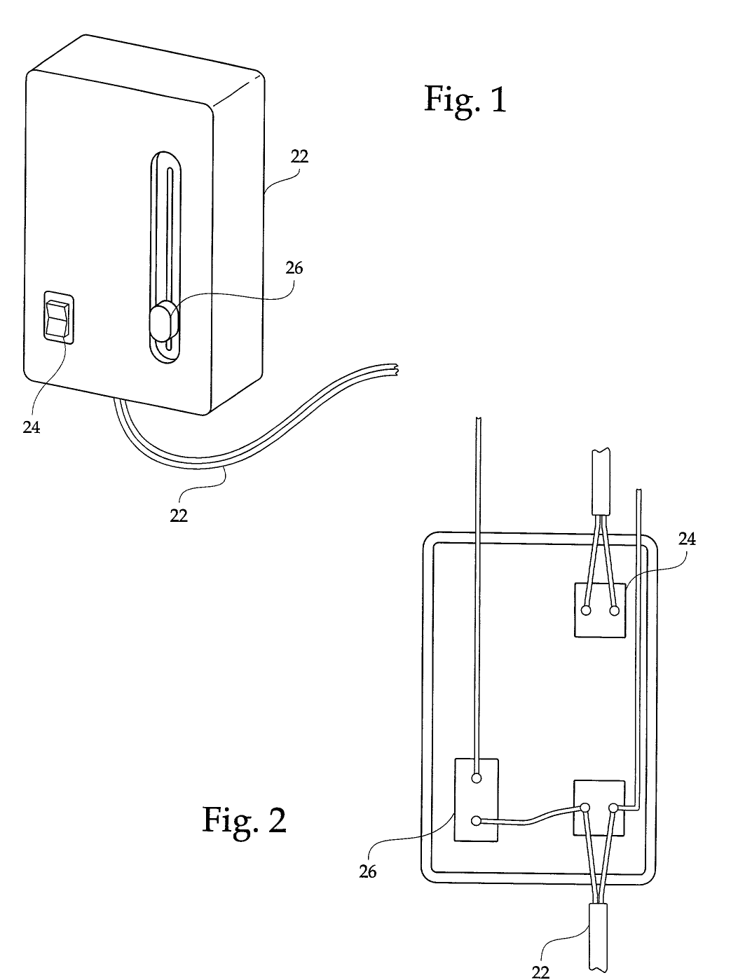

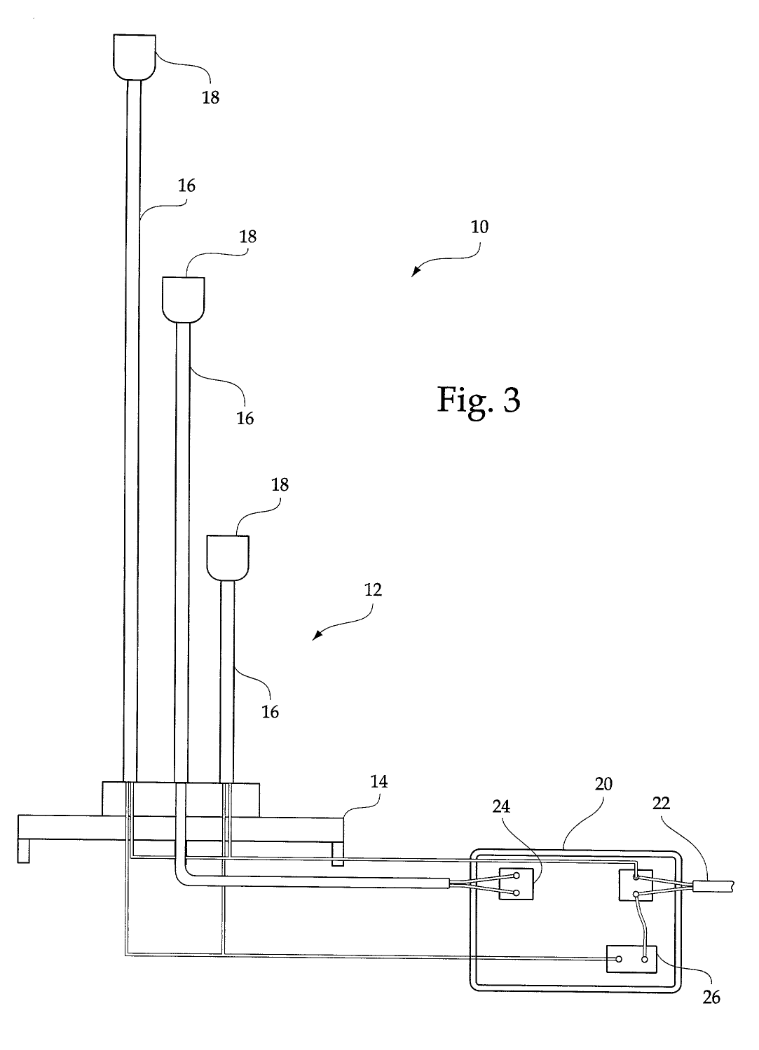

With reference now to the drawings, and in particular, to FIGS. 1 through 3 thereof, the preferred embodiment of the new and improved dimmable multi-bulb light fixture embodying the principles and concepts of the present invention and generally designated by the reference number 10 will be described.

Specifically, it will be noted in the various Figures that the device relates to a dimmable multi-bulb light fixture for allowing a single bulb to be controlled separately from other bulbs. In its broadest context, the device consists of a light portion and control panel. Such components are individually configured and correlated with respect to each other so as to attain the desired objective.

The light portion 12 includes a base portion 14 having three light sockets 16 extending upwardly therefrom. The light sockets 16 are positioned at different elevations and have an open upper end 18 for receiving a light bulb therein. The light portion could also be provided with more or less light sockets depending on the end use desired. Additionally, numerous types of unique decorative covers can be positioned over the light sockets 16.

The control panel 20 is in communication with the light portion 12. The control panel 20 includes a single power cord 22 extending outwardly therefrom for coupling with a standard electrical outlet. All of the light sockets 16 will be powered through the single power cord 22. The control panel 20 includes a power switch 24 for controlling the three light sockets 16 individually and jointly. The power switch 24 can be either a toggle or a slide switch. The control panel 20 includes a dimmer switch 26 for controlling the three light sockets 16 individually and jointly.

Thus, the present invention is designed to allow either all or one or two of the light sockets 16 to be activated, deactivated, and adjusted for brilliance.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and the manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modification and changes will readily occur to those skilled in the art, it is not desired to limit the invention to the exact construction and operation shown and described, and accordingly, all suitable modification and equivalents may be resorted to, falling within the scope of the invention.

What is claimed as being new and desired to be protected by Letters Patent of the United States is as follows:

1. A dimmable multi-bulb light fixture for allowing a single bulb to be controlled separately from other bulbs comprising, in combination:
a light portion including a base portion having three light sockets extending upwardly therefrom, the light sockets being positioned at different elevations and having an open upper end for receiving a light bulb therein; and
a control panel in communication with the light portion, the control panel including a single power cord extending outwardly therefrom for coupling with a standard electrical outlet, the control panel including a power switch for controlling the three light sockets individually and jointly, the control panel including a dimmer switch for controlling the three light sockets individually and jointly.

2. A dimmable multi-bulb light fixture for allowing a single bulb to be controlled separately from other bulbs comprising, in combination:
a light portion including a base portion having a plurality of light sockets extending upwardly therefrom, the light sockets being positioned at different elevations and having an open upper end for receiving a light bulb therein; and
a control panel in communication with the light portion, the control panel including a single power cord extending outwardly therefrom for coupling with a standard electrical outlet, the control panel including a power switch for controlling the three light sockets individually and jointly, the control panel including a dimmer switch for controlling the three light sockets individually and jointly.
